(19) United States
(12) Patent Application Publication
(10) Pub. No.: US 2006/0290629 A1
(43) Pub. Date: Dec. 28, 2006

(54) Positive and Negative Voltage Sources

(76) Inventors: Bi-Hsien Chen, Ping-Tung Hsien (TW); Yi-Min Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/425,711

(22) Filed: Jun. 22, 2006

Related U.S. Application Data
(60) Provisional application No. 60/595,302, filed on Jun. 22, 2005.

(51) Int. Cl. G09G 3/36

(52) U.S. Cl. 345/91

(57) ABSTRACT

A plasma display panel voltage source includes a first capacitor electrically connected to a first voltage and a second capacitor electrically connected in series with the first capacitor and electrically connected to a second voltage, wherein a required voltage is produced between the first capacitor and the second capacitor. The required voltage can be a positive or negative voltage, and the first and second voltages can be any one of positive voltages, negative voltages, or ground.

### CROSS REFERENCE TO RELATED APPLICATIONS

This application claims the benefit of the filing date of U.S. provisional patent application Ser. No. 60/595,302, filed Jun. 22, 2005, the contents of which are hereby incorporated by reference.

### BACKGROUND OF THE INVENTION

1. Field of the Invention

The present invention relates to the formation of positive and negative voltage sources, and more specifically, to the formation of positive and negative voltage sources for plasma display panel (PDP).

2. Description of the Prior Art

Recently flat panel display (FPDs) with their flat, thin form factor and high-resolution image quality are getting more and more attention and undergoing explosive growth in the consumer market. The major types of FPDs include the plasma display panel (PDP), the liquid crystal display (LCD), and the rear projection display, featuring several shared benefits (their flat, thin form factor and undistorted, fixed-pixel image rendering) and their own unique advantages. Among them PDP continues to best fill the needs of home theater enthusiasts seeking premium-quality large-screen display devices due to several inherent benefits of the technology: premium display quality with rich, accurate and lifelike colors; wide viewing angle with equivalently stunning brightness; high contrast in both light and dark rooms; and excellent motion handling and screen integrity over the long haul. As a result PDP technology remains the benchmark and de facto standard that consumers seek when considering the purchase of flat panel home theater display devices.

A typical PDP has two parallel sheets of glass, which enclose a gas mixture usually composed of neon and xenon that is contained in millions of tiny cells sandwiched in between the glass. Electricity, sent through an array of electrodes that are in close proximity to the cells, excites the gas, resulting in a discharge of ultraviolet light. The light then strikes a phosphor coating on the inside of the glass, which causes the emission of red, blue or green visible light. According to the driving methods, there are two kinds of plasma display device: an alternating current (AC) plasma display device and a direct current (DC) plasma display device. These are defined depending on whether the polarity of voltage applied to maintain discharge is varied with time or not. The AC plasma display device is the mainstream of this display technology because of lower power consumption and longer lifetime.

It is necessary to form several positive and negative voltage sources for displaying the PDP. The different voltages will be implemented for different functions and will be used during different periods, for example, the reset period, address period, and display period. In current design, the topologies of forward, flyback, buck, boost, etc. have been implemented for the formation of these voltage sources.

### SUMMARY OF THE INVENTION

It is therefore an objective of the invention to provide positive and negative voltage sources for a plasma display panel.

Briefly summarized, the claimed plasma display panel voltage source includes a first capacitor electrically connected to a first voltage and a second capacitor electrically connected in series with the first capacitor and electrically connected to a second voltage, wherein a required voltage is produced between the first capacitor and the second capacitor. The required voltage can be a positive or negative voltage, and the first and second voltages can be any one of positive voltages, negative voltages, or ground.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 12 are voltage sources according to first through twelfth embodiments of the present invention.

### DETAILED DESCRIPTION

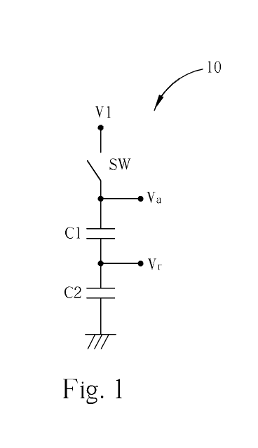

The present invention provides numerous positive and negative voltage sources for a PDP. Please refer to FIG. 1. FIG. 1 shows a voltage source 10 according to a first embodiment of the present invention. A voltage is supplied through a voltage source V1. The voltage source can either provide a positive voltage or a negative voltage, although the following description will assume a positive voltage is used. A first capacitor C1 and a second capacitor C2 are electrically connected between the voltage source V1 and ground in series. A switch SW is electrically connected between the voltage source V1 and the first capacitor C1. Voltage Va is the voltage potential between the switch SW and the first capacitor C1. The voltage source 10 outputs the required voltage Vr at a node between the first capacitor C1 and the second capacitor C2. Since the first and second capacitors C1 and C2 are impedances, the first and second capacitors C1 and C2 act as a voltage divider. Therefore, the required voltage Vr is calculated to be equal to [C1/(C1+C2)]*Va. Thus, the required voltage Vr is output by the voltage source 10, and can be adjusted by changing the capacitances of the first capacitor C1 and the second capacitor C2. Controlling the switch SW can regulate the required voltage Vr.

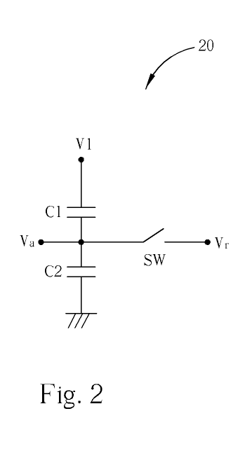

Please refer to FIG. 2. FIG. 2 shows a plasma panel display voltage source 20 according to a second embodiment of the present invention. Like the voltage source 10 shown in FIG. 1, the voltage source 20 contains the first capacitor C1 and the second capacitor C2 electrically connected in series between the voltage source V1 and ground. Differing from the voltage source 10, the voltage source 20 contains the switch SW between the node connecting the first capacitor C1 and the second capacitor C2 (having voltage Va) and a node at which the required voltage Vr is produced. Therefore, the required voltage Vr is calculated to be equal to [C1/(C1+C2)]*Va.

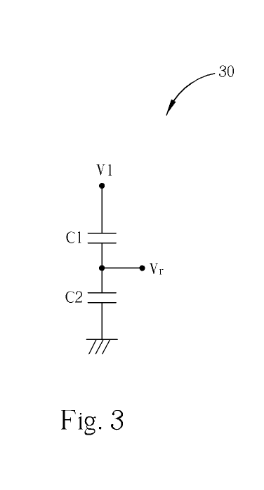

Please refer to FIG. 3. FIG. 3 shows a plasma panel display voltage source 30 according to a third embodiment of the present invention. Like the voltage source 10 shown in FIG. 1, the voltage source 30 contains the first capacitor C1 and the second capacitor C2 electrically connected in series between the voltage source V1 and ground. Differing from the voltage source 10, the voltage source 30 does not contain a switch. Therefore, the required voltage Vr is calculated to be equal to [C1/(C1+C2)]*V1.

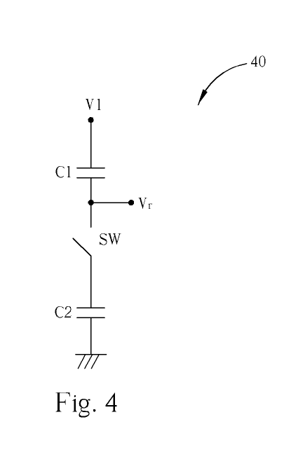

Please refer to FIG. 4. FIG. 4 shows a plasma panel display voltage source 40 according to a fourth embodiment of the present invention. Like the voltage source 10 shown in FIG. 1, the voltage source 40 contains the first capacitor C1 and the second capacitor C2 electrically connected in series between the voltage source V1 and ground. Differing from the voltage source 10, the voltage source 40 contains the switch SW between the first capacitor C1 and the second capacitor C2. The required voltage Vr is produced at a node connecting the first capacitor C1 and the switch SW.

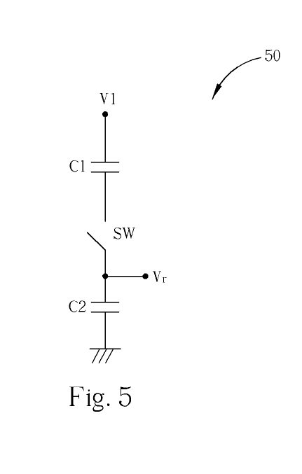

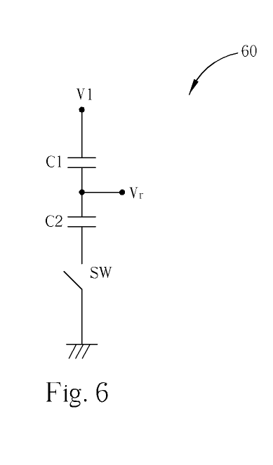

FIGS. 5 and 6 show plasma panel display voltage sources 50 and 60 according to fifth and sixth embodiments of the present invention. In the voltage source 50, the switch SW is electrically connected between the first capacitor C1 and the second capacitor C2. The required voltage Vr is produced at a node connecting the switch SW and the second capacitor C2. In the voltage source 60, the switch SW is electrically connected between the second capacitor C2 and ground.

In the voltage sources 10, 20, 40, 50, 60, controlling the switch SW can regulate the required voltage Vr. In addition, changing the capacitances of the first capacitor C1 and the second capacitor C2 will change the value of the required voltage Vr.

In the embodiments shown in FIGS. 1-6, if the voltage source V1 has a positive voltage potential, the required voltage Vr will also have a positive voltage potential since the value of the required voltage Vr must be between the voltage potentials of the voltage source V1 and ground. On the other hand, the voltage source V1 can also have a negative voltage potential. In this case, the required voltage Vr will then have a negative voltage potential.

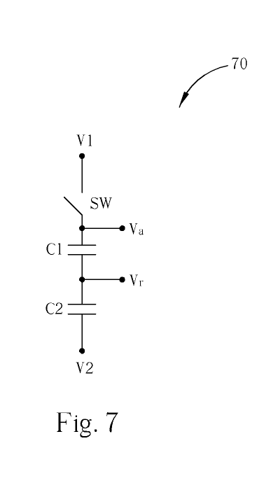

Please refer to FIG. 7. FIG. 7 shows a plasma panel display voltage source 70 according to a seventh embodiment of the present invention. A first voltage is supplied through a first voltage source V1, and a second voltage is supplied through a second voltage source V2. The first and second voltage sources V1 and V2 can either supply positive or negative voltages, and V1 can either be greater or less than V2. Like the embodiments described above, the first capacitor C1 and the second capacitor C2 are electrically connected in series. The switch SW is electrically connected between the first voltage source V1 and the first capacitor C1, and the second capacitor C2 is electrically connected between the first capacitor C1 and the second voltage source V2. Voltage Va is the voltage potential between the switch SW and the first capacitor C1. The voltage source 70 outputs the required voltage Vr at a node between the first capacitor C1 and the second capacitor C2. The required voltage Vr will have a voltage potential value between the voltage potentials of V1 and V2, and can be adjusted by adjusting the capacitances of the first capacitor C1 and the second capacitor C2, and can be regulated by controlling the switch SW.

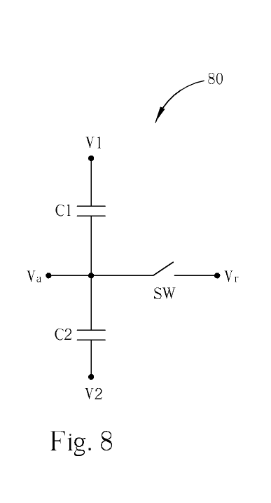

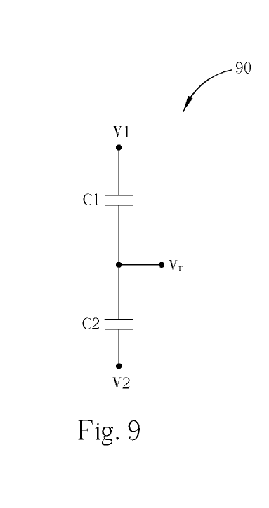

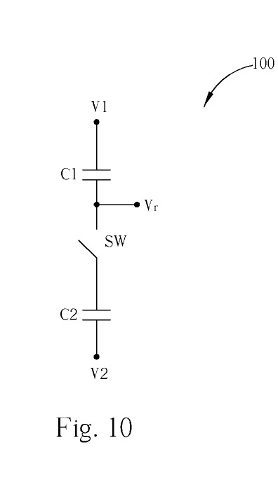

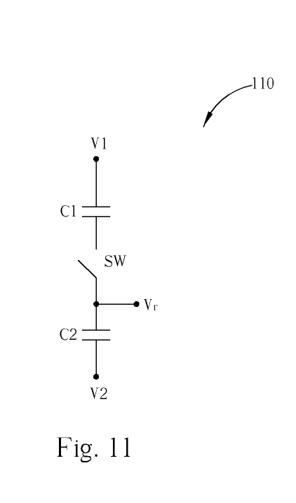

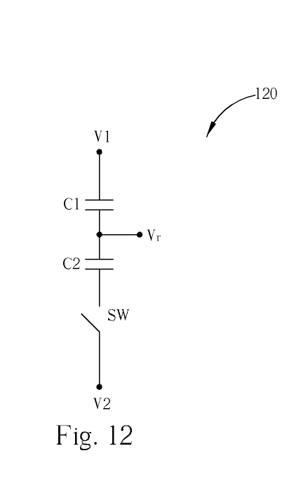

FIGS. 8-12 illustrate plasma panel display voltage sources 80, 90, 100, 110, and 120 according to the eighth through twelfth embodiments of the present invention. The voltage sources 80, 90, 100, 110, and 120 are similar to the voltage sources 20, 30, 40, 50, and 60 shown in FIGS. 2-6, but two voltage sources V1 and V2 are used instead of a single voltage source V1 along with a connection to ground. Therefore, the required voltage Vr will have a voltage potential value between the voltage potentials of V1 and V2 instead of between V1 and ground. The values of V1 and V2 can be positive or negative, and there are no restrictions on the relative magnitudes of V1 and V2.

In summary, the present invention offers several voltage sources for providing positive or negative voltage sources for PDP driving waveforms. A switch can also be used for providing greater precision when creating the required voltage potential.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A plasma display panel voltage source comprising:
a first capacitor electrically connected to a first voltage; and
a second capacitor electrically connected in series with the first capacitor and electrically connected to a second voltage;
wherein a required voltage is produced between the first capacitor and the second capacitor.

2. The plasma display panel voltage source of claim 1, wherein the first voltage is greater than the second voltage.

3. The plasma display panel voltage source of claim 2, wherein the first voltage is a positive voltage supplied by a voltage source and the second voltage is ground.

4. The plasma display panel voltage source of claim 2, wherein the first voltage is supplied by a first voltage source and the second voltage is supplied by a second voltage source.

5. The plasma display panel voltage source of claim 2, wherein the first voltage is ground and the second voltage is a negative voltage supplied by a voltage source.

6. The plasma display panel voltage source of claim 2, further comprising a switch electrically connected between the first voltage and the first capacitor, wherein the required voltage is produced at a node connecting the first capacitor and the second capacitor.

7. The plasma display panel voltage source of claim 2, further comprising a switch electrically connected between a first node connecting the first capacitor and the second capacitor and a second node at which the required voltage is produced.

8. The plasma display panel voltage source of claim 2, wherein the required voltage is produced at a node connecting the first capacitor and the second capacitor.

9. The plasma display panel voltage source of claim 2, further comprising a switch electrically connected between the first capacitor and the second capacitor, and the required voltage is produced at a node connecting the first capacitor and the switch.

10. The plasma display panel voltage source of claim 2, further comprising a switch electrically connected between the first capacitor and the second capacitor, and the required voltage is produced at a node connecting the second capacitor and the switch.

11. The plasma display panel voltage source of claim 2, further comprising a switch electrically connected between the second capacitor and the second voltage, wherein the required voltage is produced at a node connecting the first capacitor and the second capacitor.

12. The plasma display panel voltage source of claim 1, wherein the first voltage is less than the second voltage.

13. The plasma display panel voltage source of claim 12, wherein the first voltage is a negative voltage supplied by a voltage source and the second voltage is ground.

14. The plasma display panel voltage source of claim 12, wherein the first voltage is supplied by a first voltage source and the second voltage is supplied by a second voltage source.

15. The plasma display panel voltage source of claim 12, wherein the first voltage is ground and the second voltage is a positive voltage supplied by a voltage source.

16. The plasma display panel voltage source of claim 12, further comprising a switch electrically connected between the first voltage and the first capacitor, wherein the required voltage is produced at a node connecting the first capacitor and the second capacitor.

17. The plasma display panel voltage source of claim 12, further comprising a switch electrically connected between a first node connecting the first capacitor and the second capacitor and a second node at which the required voltage is produced.

18. The plasma display panel voltage source of claim 12, wherein the required voltage is produced at a node connecting the first capacitor and the second capacitor.

19. The plasma display panel voltage source of claim 12, further comprising a switch electrically connected between the first capacitor and the second capacitor, and the required voltage is produced at a node connecting the first capacitor and the switch.

20. The plasma display panel voltage source of claim 12, further comprising a switch electrically connected between the first capacitor and the second capacitor, and the required voltage is produced at a node connecting the second capacitor and the switch.

21. The plasma display panel voltage source of claim 12, further comprising a switch electrically connected between the second capacitor and the second voltage, wherein the required voltage is produced at a node connecting the first capacitor and the second capacitor.
